(19) United States
(12) Patent Application Publication
(10) Pub. No.: US 2011/0029140 A1
(43) Pub. Date: Feb. 3, 2011

(54) Central control and instrumentation system for a technical installation and method for operating a central control and instrumentation system

(76) Inventors: Carsten Jordan, Erlangen (DE); Rainer Speh, Weiterstadt (DE); Michael Unkelbach, Buckenhof (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/677,859

(22) PCT Filed: Sep. 12, 2008
(86) PCT No.: PCT/EP2008/062159

§ 371 Date: Oct. 14, 2010

(30) Foreign Application Priority Data
Sep. 13, 2007 (DE) 10 2007 043 795.3

(51) Int. Cl. G05B 15/02; G05B 19/048

(52) U.S. Cl. 700/286; 700/9

(57) ABSTRACT

A central control and instrumentation system for a technical installation is provided. The central control and instrumentation system for a technical installation includes a plurality of functional modules which are interconnected for data transmission, monitored by a central control module and activated, when needed, as a function of a triggering parameter. The triggering parameter provided for activating the functional modules by the control module is predefined by a user.

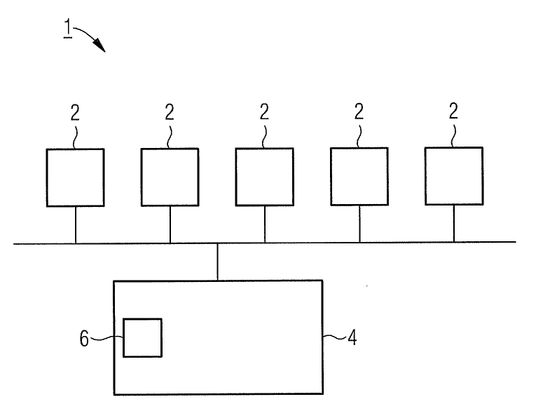

### CROSS REFERENCE TO RELATED APPLICATIONS

This application is the US National Stage of International Application No. PCT/EP2008/062159, filed Sep. 12, 2008 and claims the benefit thereof. The International Application claims the benefits of German application No. 10 2007 043 795.3 DE filed Sep. 13, 2007. All of the applications are incorporated by reference herein in their entirety.

### FIELD OF INVENTION

The invention relates to a central control and instrumentation system for a technical installation, in particular a power station, comprising a plurality of functional modules which are interconnected for data communication purposes and which are monitored and where necessary activated by a central control module as a function of a triggering parameter. It further relates to a method for operating a central control and instrumentation system of said type.

### BACKGROUND OF INVENTION

In large-scale technical installations such as, for example, power stations or the like, process control systems or central control and instrumentation systems are typically deployed for the purpose of monitoring and controlling the system processes of the installation. Central control and instrumentation systems of this type typically comprise a multiplicity of functional modules or the like, each of which performs a specific task in the monitoring and control of the system processes of the installation, for example the monitoring and control of individual components, the acquisition of specific process parameters, the management and control of the data streams being generated or the like. In so doing the functional modules typically exchange a multiplicity of data with one another in a suitable manner as a function of situation and state.

For suitable control and activation of the functional modules as well as for monitoring the general process workflow in a central control and instrumentation system of the aforesaid kind, the functional modules, which for their part can be configured as autonomous hardware components, as software modules or as hybrids thereof, are typically assigned a higher-ranking central control module which monitors and where necessary controls the general data transfer as well as the orderly sequence in the processing of the data streams being generated. The functional modules in particular are suitably controlled by way of a central control module of said type, which is sometimes also referred to as a “scheduler” or “task manager”, and after being supplied with suitable input data are prompted to output corresponding output data that is dependent on the particular function of the module.

Especially in central control and instrumentation systems in highly complex large-scale technical installations there is generally a requirement to monitor and control a multiplicity of components having highly complex procedural flow sequences. Particularly in such types of central control and instrumentation systems, which accordingly have a comparatively high degree of complexity in terms of the number, configuration and structure of their respective functional modules, proper adherence to specified message sequences or possibly also to message sequences conforming to external standards is usually of particular importance for correct program execution and data exchange and hence also for a high level of operational reliability. In this case it is important in particular to ensure that the functional modules are controlled in a suitable and timely manner such that the output data supplied by them in each case, which in turn is required as input data for other functional modules, is available at the right time and can be forwarded in a suitable form to the destination functional module. Furthermore there is a general requirement for the proper management of such highly complex processes to provide suitable data streams and to maintain the synchronization of heterogeneous units with one another with precision.

In order to enable this the functional modules are controlled and activated via the central control module usually with the aid of a triggering parameter that is monitored in the control module, on the basis of which parameter it can be detected within the control module that in accordance with the current system state of the installation it is now necessary or desired to activate the respective functional module. In view of the high level of complexity of modern-day central control and instrumentation systems, a unique triggering parameter that is available at all times in all the functional modules as well as in the higher-ranking control system is necessary in this case to ensure reliable and consistent system management. With regard to these requirements reference is made for this purpose to the system time, with the result that typical central control and instrumentation systems or automation systems are operated under realtime control.

In systems of this kind the functional modules are managed by means of suitably time-staggered activation, in which it can be provided, for example, that one functional module is to be activated later than another functional module by a predefinable time interval of, for example, 100 ms.

In comparatively complex central control and instrumentation or automation systems in particular, other types of calculations are required for proper and efficient process management or also for other purposes, for example for logging or simulation purposes, in addition to the aforesaid workflows based on a realtime parameter as the triggering parameter or so-called realtime calculations. For example, it may be necessary within the context of diagnostics, verifications or error checks to perform calculations for times in the past or, for example, to perform calculations for times in the future for forecasts, trend estimations and the like. For purposes of this kind and also for simulation purposes which may be necessary, for example, in connection with personnel training programs or the like and in which computing functions must specifically be executed independently of the current time that is available in the computer system, different systems are typically provided within the central control and instrumentation system, each separate system having, inter alia, an autonomous engineering and/or user interface and hence an autonomous runtime environment.

However, as a result of the individualization and implementation of systems that are so diverse per se for covering the necessary performance spectrum, a comparatively high level of system complexity is produced which in turn necessitates a high overhead in terms of the manufacture and maintenance of the individual systems.

### SUMMARY OF INVENTION

The object underlying the invention is therefore to disclose a central control and instrumentation system for a technical installation of the aforementioned type by means of which the cited functionality range can be performed in a comparatively simple and resource-saving manner. A further object is to disclose a particularly suitable method for operating the central control and instrumentation system.

With regard to the central control and instrumentation system, this object is achieved according to the invention in that the triggering parameter provided for the activation of the functional modules by means of the control module can be predefined by a user.

The invention is in this case based on the consideration that it is possible, by consistently refraining from providing different systems or engineering interfaces even in view of the multiplicity of desired functionalities, to cover a comparatively large number of functionalities such as, for example, realtime calculations on the one hand and diagnostic, verification, forecasting or other functionalities on the other hand with a system which is kept comparatively simple and hence with correspondingly low maintenance and installation overhead. In order nonetheless to be able to implement realtime-based automation workflows on the one hand and realtime-independent automation workflows on the other hand while having recourse to a standardized system and a standardized engineering interface, a runtime environment or platform should be provided which can be used both for cyclical realtime processing and for freely configurable calculation periods or workflows.

Toward that end a runtime environment is provided in which different, in particular different parameterizable, task managers or schedulers can be deployed. For that purpose provision is made to use an editable or user-modifiable triggering parameter for workflow scheduling via the control module, while renouncing the established principle of the use of real time as a triggering parameter firmly rooted in the control module. Thus it is possible to deploy, within the same runtime environment, a scheduler or task manager having differently based, user-modifiable workflow scheduling.

In order at the same time to be able to implement, within a standardized runtime environment, runtime systems of different types already in terms of their basic structure, a user-modifiable time parameter is advantageously provided and can be selected as a triggering parameter alternatively to a realtime parameter. This means in particular that a time value different from the real time can be specified such that it is made possible in a particularly simple manner to resort to functional modules with different timestamps, in other words, for example, to process parameters or the like in the past or even in the future. In particular process values from an archive can be suitably incorporated in this case, wherein diagnostic or verification functions can be integrated in a particularly simple manner via the corresponding use of time values when times in the past are specified, and forecasting functions in the case of times in the future being specified. In particular it is possible here, by means of the user-defined specification of a selectable time parameter as a triggering parameter, to integrate, within one and the same runtime environment, modules or functional modules of all kinds which would not in fact be addressable in the case of a purely realtime-based system.

In another or alternative advantageous embodiment an event-driven parameter is provided as a triggering parameter. In this way it is made possible in particular for a process workflow to be controlled via a correspondingly parameterized and configured central control module substantially independently of the actual time sequence, but rather as a function of the event chains present in process logic terms. In this way it can be ensured, for example, that intermediate results required for the activation of one functional module are initially waited for and provided, with the following functional module being activated immediately after the arrival of said results or intermediate values as the triggering event. In an event-driven system of this kind individual process steps can be processed sequentially while the best possible use is made of the available system resources, in other words as quickly as possible.

With regard to the method, the cited object is achieved in that the functional modules are activated taking into account a triggering parameter that is specified by a user.

The advantages achieved by means of the invention consist in particular in the fact that it is possible, by means of the selection possibility provided to the user, i.e. the triggering parameter, on the basis of which the functional modules are activated via the central control module, to specify as a function of situation or based on need the performance of a comparatively large number of process workflows and operating functionalities while maintaining a common runtime environment and within one and the same system. Through the thus enabled maintaining of a single runtime environment for different types of functionalities such as realtime calculations for automation on the one hand and also calculations for times in the past within the context of diagnostic or verification functions or in the future within the context of forecasting functions on the other hand it is possible to provide all the cited functionalities within one and the same system with a particularly low investment in terms of time, costs and resources.

It is therefore no longer necessary to have recourse to other modules or functional modules, in particular to external applications or separate systems such as simulators, for example. As a result the expenditure for producing software modules, engineering costs and the development costs for automation systems can also be kept particularly low overall, since the same functional building blocks or modules can always be used in all application areas.

### BRIEF DESCRIPTION OF THE DRAWINGS

An exemplary embodiment of the invention is explained in more detail with reference to a drawing in which the figure schematically shows a central control and instrumentation system.

### DETAILED DESCRIPTION OF INVENTION

The central control and instrumentation system 1 according to the figure is provided for controlling and monitoring the system processes in a comparatively complex technical installation, namely in the exemplary embodiment of a power station. For that purpose the central control and instrumentation system 1 comprises a multiplicity of functional modules 2, each of which is specifically configured for performing individual functions or tasks within the framework of the overall process flow sequence. In this case the functional modules 2 can be embodied as separate hardware components, as independent software modules or as a combination of both. By means of the individual functional modules 2 the relevant components of the power station in particular can in this case be individually monitored in respect of their operating state and suitably controlled, wherein further functional modules 2 can be provided for the specific monitoring of measurement parameters, for determining intermediate results, for monitoring the data streams and the like.

In order to coordinate the data streams, the data exchange between individual functional modules 2 and the like, the central control and instrumentation system 1 is additionally provided with a central control module 4 which monitors and where necessary suitably controls the functional modules 2. In this case the higher-ranking control module 4, also referred to as a “scheduler” or “task manager”, activates individual functional modules 2 as necessary and where appropriate and thereby initiates the output of suitable output signals by the respective functional module 2, which signals can be used in turn as input values for other functional modules 2.

In this case the functional modules 2 are activated and their functionalities triggered from the central control module 4 on the basis of a triggering parameter which is suitably monitored in the control module 4. If the central control and instrumentation system 1 is configured as an automation system for realtime calculations, said triggering parameter could in this case be a realtime parameter that is suitably called upon for controlling the functional workflows. In a configuration scenario of this kind it could, for example, be provided to activate one of the functional modules 2 in a time-staggered manner, offset by a predefined time interval of, for example, 100 ms or the like, after the activation of another functional module 2 has taken place. When the real time is specified as a triggering parameter, the control module 4 therefore operates in a comparable manner to regular control modules.

As well as this, however, the central control and instrumentation system 1 is also configured for integrating further functionalities within a common runtime environment for the user in addition to automation processes based on realtime calculations. Examples of further functionalities that can be provided in this context are functionalities related to times lying in the past such as, for example, diagnoses, verifications or the like, and by specifying suitable different timestamps, values lying in the past can be suitably determined or also obtained by having recourse to process archives. In addition or alternatively, functionalities based on time values in the future, such as forecasts, predictions or trends for example, can also be integrated as further functionalities into the common runtime environment.

In addition, in turn, further functionalities can be integrated in which, while refraining from a time-based system, the suitable activation of functional modules 2 can be performed overall in an event-driven manner and thus—given suitable availability of all starting requirements—corresponding functions are triggered as early as possible with the best possible use of all system resources. Functionalities of this kind can be resorted to in particular for simulation purposes where time-compressed processing of the process workflows is desirable.

In order to enable different types of functionalities to be provided in this way in a common runtime environment, the process control via the control module 4 in the central control and instrumentation system 1 is provided via a triggering parameter which can be specified by a user and in particular can be selected from a stored group of possible triggering parameters. For that purpose the central control module 4 has a specifically allocated memory area 6 in which a suitable triggering parameter can be selected by the user from a group of stored possible triggering parameters via an input device that is not shown in further detail, for example a screen-keyboard unit. In the exemplary embodiment a time value that is different or diverges from the real time can be selected in this case as a possible triggering parameter as an alternative to the real time. Alternatively an event-driven system environment can also be selected as the triggering parameter, in which system environment the triggering or activation of a functional module 2 takes place immediately when the input parameters necessary for use of the respective functional module 2 are all present and available in the central control module 4.

By means of the option offered to the user to select a suitable or currently desired triggering parameter it is thus possible, within a single, common runtime environment, also in functionalities or modes of different types to use all of the functional modules 2 or other modular building blocks for all types of calculation, i.e. a calculation in real time or a calculation in an alternative system time or a calculation on an event-driven basis. Having recourse to external applications or separate systems for special applications, for example for simulation purposes or the like, is therefore not necessary.

1.-4. (canceled)

5. A central control and instrumentation system for a technical installation, comprising:
a plurality of functional modules; and
a central control module,
wherein the plurality of functional modules are interconnected for data communication purposes and are monitored, and
wherein when necessary, the plurality of functional modules are activated by a central control module as a function of a triggering parameter,
wherein a triggering parameter is provided to activate the plurality of functional modules by the control module and
wherein the triggering parameter may be specified by a user.

6. The central control and instrumentation system as claimed in claim 5, wherein a user-modifiable time parameter is provided as the triggering parameter.

7. The central control and instrumentation system as claimed in claim 5, wherein an event-driven parameter is provided as the triggering parameter.

8. The central control and instrumentation system as claimed in claim 5, wherein the technical installation is a power station.

9. The central control and instrumentation system as claimed in claim 5, wherein the triggering parameter is selected from a stored group of possible triggering parameters.

10. The central control and instrumentation system as claimed in claim 9, wherein the central control module includes an allocated memory which stores the stored group of possible triggering parameters.

11. The central control and instrumentation system as claimed in claim 5, wherein the plurality of functional modules are selected from the group consisting of hardware components, independent software modules, and combinations thereof.

12. A method for operating a central control and instrumentation system, comprising:
activating a plurality of functional modules by taking into account a triggering parameter specified by a user.

13. The method as claimed in claim 12, wherein a user-modifiable time parameter is provided as the triggering parameter.

14. The method as claimed in claim 12, wherein an event-driven parameter is provided as the triggering parameter.

15. The method as claimed in claim 12, wherein a central control module monitors and when necessary activates the plurality of functional modules.
